(19) United States
(12) Patent Application Publication
(10) Pub. No.: US 2009/0037275 A1
(43) Pub. Date: Feb. 5, 2009

(54) Consolidated membership/rewards card system

(76) Inventor: Michael J. Pollio, Long Valley, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/888,983

(22) Filed: Aug. 3, 2007

(51) Int. Cl. G06Q 30/00

(52) U.S. Cl. 705/14

(57) ABSTRACT

A bank or credit card issuing authority provided consolidated membership/rewards card has standard credit card features including cardholder's name, card number, expiration date, secret code and a permanently coded permanent magnetic strip. The card has a programmable second magnetic strip with inductors directly below the strip energized by a CPU in the card recording a merchant provided loyalty or discount number. The cardholder selects a merchant from a list displayed card screen by pressing up and down buttons and a ‘go’ button to program the second magnetic strip. A USB connector associated with the card is used for uploading merchant data from a personal computer and transmitting the card discount number to a USB enabled cash register. The cash register provides eligible discounts for purchases upon receipt of the card discount number by swiping the second magnetic strip or by establishing USB connectivity. Payment is made using the permanent magnetic strip of the card or by other payment means. Discounts and membership rewards are thereby provided to a cardholder without need for carrying a plurality of merchant issued membership/rewards cards. Credit card functionality facilitates immediate payment for the purchases made.

### BACKGROUND OF THE INVENTION

1. Field of the Invention

The present invention relates to cardholder systems that facilitate purchase of merchandise and services; and, more particularly, to a consolidated membership/rewards card system that includes credit card functionality and integration of a plurality of merchant issued membership/rewards cards into a single card, and which provides the cardholder with discounts at predetermined merchant locations for specified purchases as well as an option for credit card functionality that facilitates payment for purchases made.

2. Description of the Prior Art

Many patents address issues related to membership or reward cards and use a variety of means to keep track of merchant issued membership/reward cards. In its simplest configuration, a card carries a plurality of bar codes or magnetic strips, each representing the membership card number. In practice, the cardholder must selectively point the appropriate bar code to a scanner, which oftentimes reads inappropriate bar codes that provide no discount for purchases at the merchant location. Similarly, magnetic strips must be oriented and placed at specific distances for readability by magnetic card readers. Parallel placement of magnetic strips at different distances from a reader's edge requires differently configured magnetic card readers and oftentimes prevents acceptance of various card iterations. Other devices do not provide credit card functionality to facilitate payment for purchases made at the merchant store.

U.S. Pat. No. 5,544,086 to Davis et al. discloses information consolidation within a transaction network. This information collection system collects information from a variety of terminals, such as automatic teller machines, point of sale machines and the like. The information is sent to a collection device; and thereafter to a settlement device where the information is stored. This transaction network only collects data. It does not provide merchant specific discounts based on merchant-issued discount card numbers.

U.S. Pat. No. 5,806,045 to Biorge et al. discloses a method and system for allocating and redeeming incentive credits between a portable device and a base device. This customer incentive system involves a plurality of service or merchandise providers and comprises a customer-carried, portable device, a provider device, and a base device. To earn incentive credits, the customer enters into a transaction with one of the providers participating in the incentive system. A transaction amount is derived from the transaction and, based on this amount, an incentive credit amount is computed. The base device performs this computation by deriving an incentive code and cross-referencing this incentive code with all customer incentive codes stored on the customer-carried device and incentive program codes stored on the provider device to derive an incentive rate. This incentive rate is applied to the transaction amount to derive the incentive amount. The incentive amount is stored on the customer-carried device. To redeem the incentive credits stored on the customer-carried device, the customer enters into a second transaction with the same provider or another participating provider. A second transaction amount is derived from this transaction and the customer may choose to redeem some or all of the incentive credits stored on the customer-carried device to lower the transaction amount. When incentive credits are redeemed, they are subtracted from the incentive amount on the customer-carried device. By using a customer-carried device, transactions may be conducted off-line. This portable system collects information on a first purchase and stores incentive credits in its memory. During a second purchase at the same merchant or a different merchant, the incentive credits are recovered to reduce the sale price of merchandise acquired during the second purchase. This portable device does not communicate with a merchant incentive or discount data card processing system during every purchase and provide appropriate merchant specific discounts.

U.S. Pat. No. 5,924,080 to Johnson discloses a computerized discount redemption system. The centralized computer system requires the customer to become a member of the redemption system and to be provided with an identification number. Each of the plurality of merchants may have discounts on merchandize as advertised and be tracked by the redemption system. Back and forth communication between the merchant's cash register and the computerized redemption system determines the discounts that will be issued for the purchase of the products. Thus the discounts are not provided by the merchant using a merchant provided discount card, but by a centralized system that relies on advertisements, etc. If the merchant posted discount is not present in the computerized discount redemption system database, the customer does not receive that discount, since the discount is not provided locally within the control of the merchant.

U.S. Pat. No. 6,003,769 to Ebbing discloses a system for reading and erasing data on a chip card. At least one set of data associated with at least one issuer is stored on the chip card, and the sets of data associated with different issuers are mutually separated. The device has a substantially flat, hand-held housing, a current supply arranged in the housing, a read/erase device arranged in the housing, a slot in one of the narrow sides of the housing for inserting the chip card with memory into the housing in the area of the read/erase device, a control device for controlling the device and a display panel linked to the read/erase device to display as a page at least one set of data stored on the chip card. The '769 patent discloses a self-contained portable device, having a processor, keyboard, LCD display and power source. A chip card is inserted into a slot on the side of the device and is read or erased. This portable device does not communicate with other devices. Its limited keyboard functionality does not permit entering a large amount of data files. The device taught by the '769 patent is more like a personal digital assistant.

U.S. Pat. No. 6,129,274 to Suzuki discloses a system and method for updating shopping transaction history using an electronic personal digital shopping assistant. Demographic profile data, a customer's transaction history data and a customer's current incentive indicia are stored in a non-volatile memory of a machine-readable contact-type smart card within a portable personal digital shopping assistant. This is a contact type smart media card with non-volatile memory storage and optionally a magnetic strip over which data can be recorded. The smart card is inserted into an interface unit in a kiosk. The kiosk terminal, in combination with the customer's IC card is thus able to provide personalized shopping assistance and make targeted promotional recommendations to a specific customer based on that customer's personal preference information and unique transaction behavior. The system and method is able to update a customer's transaction information at the point of sale, making it available for subsequent purchasing activity with no consequent delay. A contact type smart card IC is powered by an interface of a kiosk and stores in the memory storage area of the smart card the historical details of transactions and purchases. Based on this information, the smart card recommends purchases to the customer and offers discounts on some purchases. This digital shopping assistant does not communicate with a merchant discount card to thereby enable discount pricing of merchant-selected sale merchandise.

U.S. Pat. No. 6,409,080 to Kawagishi discloses a portable electronic device and loyalty point system. This portable electronic device executes a prescribed process based on a selling amount based on a deal amount, the money value of which is input from a terminal device. An IC card is inserted into a check out machine, stores date of purchase, amount of purchase at a merchant location, and calculates loyalty points earned. The updated loyalty value is stored in the memory of the IC card. The IC card does not communicate to the cash register the merchant provided discount card number for providing automatic discount on purchases.

U.S. Patent Application No. 2002/0049631 to Williams discloses a process, system and computer readable medium for providing incentives to a plurality of retail store environments. Check out machines at a plurality of retail store merchants require customers to present a credit card and a loyalty card. The information regarding these two identities, together with purchase detail amounts are sent to a centralized incentive system through a communication link, which computes the loyalty discounts that may be provided to the customer for the purchases. The central incentive system communicates with promoter's account to receive compensation for the discounts provided and credits the retailers account accordingly. A centralized incentive clearing house system is thereby provided, which does not offer discounts at the merchant location based on loyalty or a discount card provided by the merchant. The customer discount is therefore provided by a remote central incentive system not by the merchant discount card.

U.S. Patent Application 2003/0236704 to Antonucci discloses a system and method for a multiple merchant stored value card. This smart card based system accumulates general loyalty points from a plurality of merchants. The customer may convert a subset or portion of the general loyalty points to merchant specific loyalty points according to conversion rules set forth by the merchant for getting discounts at a second merchant during purchase of products. This system does not provide a merchant provided discount card adapted to convey information during check out, in response to which the purchaser receives merchant provided loyalty discounts for purchase of selected products.

U.S. Patent Application 2005/0171898 to Bishop et al. discloses systems and methods for managing multiple accounts on an RF transaction device using secondary identification indicia. This systems and method provides management of distinct data sets on a transaction device that are provided by distinct data set owners, wherein the distinct data sets may include differing formats. The method includes the steps of: adding, by a read/write, a first data set to the financial transaction device, wherein the first data set is owned by a first owner; adding, by the read/write device, a second data set to the financial transaction device, wherein the second data set is owned by a second owner; and storing the first data set and the second data set on the financial transaction device in accordance with an owner defined format. The first and second data sets are associated with first and second owners, respectively, and are stored independently of each other. The transaction device user may be permitted to select at least one of the multiple data sets for transaction completion using a secondary identifier indicia. Where the user selects multiple accounts for transaction completion, the user may be permitted to allocate portions of a transaction to the selected transaction accounts. The transaction request may be processed in accordance with the user's allocations. This system uses a RF transaction media, which stores data sets associated with a plurality of accounts, each separated from the others and each accessed by secondary ID indicia. The RF transaction device does not provide to the system discount card numbers issued by a merchant for providing a discount during purchase of products.

U.S. Patent Application 2005/0194436 to McCaskey et al. discloses a data card. This data card facilitates a transaction and includes a card body having a front surface and a back surface. The data card has a plurality of magnetic strips that encode different data. The magnetic data contained is not a discount or loyalty card number that is provided by a merchant. Rather, the recorded structure of the magnetic strip data includes additional data such as a PIN number, etc. which are similar to coding contained on a credit card magnetic strip.

U.S. Patent Application 2006/0027647 to Deane et al. discloses a system and method for redeeming rewards and incentives. This transaction card is a conventional credit card with a magnetic strip that processes credit transactions together with a second reward strip that processes rewards through a separate system. This card is said to provide rewards for purchases from a plurality of merchants since the same financial institution that issues the credit card handles the reward system. Since the transaction card has a single magnetic strip with a number coded in it, it does not represent the loyalty credit number issued by any of the plurality of merchants used for purchases. Therefore, the transaction card does not provide usual loyalty rewards offered by a single merchant on a week-by-week basis for purchases made.

U.S. Patent Application 2006/0169768 to Gangi discloses a system for associating identification and personal data for multiple magnetic stripe cards or other sources to facilitate a transaction and related methods. This system provides a customized set of identification data to facilitate a transaction. This system facilitates an individual, consumer, entity, organization, etc. means to provide others with a secure, customized set of identification data that would facilitate a transaction or event of a specific type. The individual records personal identification data that is recorded in a plurality of magnetic strips. Use of a timing track enables use of control characters to hide additional data. When this coded magnetic card is presented, a server validates the identity even when presented by a different person allowing a transaction to proceed. This system does not communicate a discount or loyalty reward card number to be communicated to a merchant check out system; and it does not provide the customer with discounts for purchases made.

U.S. Patent Application 2006/0175405 to Fernandes et al. discloses an adaptor for magnetic stripe card reader. This adaptor allows a magnetic stripe card reader to receive information from other media such as wireless proximity chip cards while maintaining the ability to receive a magnetic stripe card. The adaptor includes a simulacrum structure of sufficiently narrow width to fit substantially permanently within the slot of the magnetic stripe reading device, while providing sufficient room for a magnetic stripe card to also be concurrently accommodated within the slot and read by the reader head. This adapter allows the magnetic stripe reader to interact with other media such as RF proximity chip cards and Infra-Red, while retaining the continuous ability to receive a magnetic stripe card. This adapter does not function to provide individual merchants with loyalty or discount card numbers during merchandise purchase to receive discounts on portions of purchases made.

U.S. Patent Application 2006/0224454 to Kantor et al. discloses tracking merchant specific reward credits and balances in a multi merchant environment utilizing one card or account number. Each customer with a membership is provided with a card having a machine readable magnetic strip that communicates with a central server wherein reward tracking files are created and maintained separately for each merchant. The membership card is associated with multiple merchants whose accounts are centrally managed but segregated from one another. In this manner a customer only needs to carry a single card while participating in promotions that are controlled and managed by separate merchants since the credits earned are stored in the memory of a central server. The reward points are redeemed at the same merchant or redeemed at a different merchant using a bartering process. The management of reward points is done remotely through a server and is not a loyalty or discount card issued by a merchant providing sale items on a week-by-week basis. The machine readable card does not have functionalities of a credit card.

U.S. Patent Application 2006/0249575 to Turner et al. discloses a system and method for redeeming rewards and incentives. This transaction card comprises a substrate having a front face and a back face, a first magnetic stripe for storing data associated with a credit account, the first magnetic stripe being located along an edge of the back face, a second magnetic stripe for storing data associated with a rewards account, the second magnetic stripe being located along another edge of the back face, and account information located on the front face, the account information being associated with the credit account and the rewards account. The first magnetic strip is associated with multiple financial accounts and the second magnetic strip is associated with a plurality of reward entities. Since the transaction card has a single rewards magnetic strip with a number coded in it, it does not represent the loyalty credit number issued by any of the plurality of merchants used for purchases. It is a rewards point managed by the financial institution, not by the merchant that issues a discount card. Therefore, the transaction card does not provide usual loyalty rewards provided by a single merchant on a week-by-week basis for purchases made.

U.S. Patent Application 200710007348 to Shah discloses membership cards. This code carrier card is issued by a code carrier provider to whom the user sends a plurality of images of bar codes from separate merchants. These images are printed on the reverse side of the card, allowing the user to carry a single card for shopping and receiving discounts at a plurality of merchant locations. The membership card is awkward since there is no indication which bar code belongs to which merchant. Accordingly, the card must be oriented correctly for reading by a bar code scanner. The bar code scanner will read any of the printed bar codes, but the customer will not receive discounts or loyalty points. The membership card lacks the functionality of a credit card.

U.S. Patent Application 2007/0063025 to Blossom discloses a selectable multi-purpose card. This selectable, multi-purpose card comprises a plurality of features stored in memory means operatively mounted on the card and selection means for allowing a user to select a feature in a few simple steps, preferably in a single step. This card is in two forms. The first form has two magnetic strips, one corresponding to a credit card and the other corresponding to a loyalty reward system. Since this loyalty reward magnetic strip is a single number, it does not represent loyalty or discount cards issued by a plurality of merchants. The second embodiment of the '025 disclosure includes a smart card chip that programs a magnetic strip for different numbers using an inductor energized by a CPU. These features are selected by pushing buttons. The second embodiment card may also communicate with other devices by radio frequency communication. Since the single magnetic strip of the second embodiment is programmed by the CPU, it cannot contain a credit card number. Magnetic codes used in credit cards contain built in security codes that are not readily accessible. Even if a security code were available, the user would be required to load from memory a particular feature, swipe the card, and wait until the magnetic strip demagnetizes. These steps would collectively take several minutes, after which the user would still be required to load the credit card number to ready it for swiping. Such a process would be time consuming and inconvenient, and would limit use of this device disclosed by the '025 application.

U.S. Patent Application 2007/0073589 to Vergeyle et al. discloses electronic capture of promotions. A plurality of different advertisements, each containing a different promotion, are depicted on electronic displays placed throughout a store. The consumer enters a consumer ID number, and the display is changed according to consumer preferences stored in the server, providing advertisements that are of interest to the consumer. The disclosure of the '589 application does not suggest providing a check out register with a merchant provided discount or loyalty number for obtaining discounts on purchased products.

U.S. Patent Application 2007/0075131 to Alberth et al. discloses a method and apparatus for managing information. A wallet carried card wirelessly communicates with a server at a merchant location to accrue loyalty points and use them for purchases. The card must communicate only over short distances in order to provide this functionality as the customer with a wallet carried card enters a store. This requirement is not clearly indicated, since the '131 application drawings depict a wallet card in communication with a tower that broadcasts the information through a large distance. The card is said to store the loyalty or reward points. However, the wallet does not enable a checkout counter to receive a merchant provided loyalty or discount card number, thereby providing discounts for purchases at the merchant's location.

Foreign Patent Application Publication JP2005115644 to Gotanda discloses an advertisement display system and program. An advertisement display is turned on, based on the details in a transaction card. The disclosure of the '644 application does not suggest communicating a merchant provided loyalty or discount card number to a check out unit to obtain discounts on purchases.

Non-Patent Publication “Smart Card” at http://www.tristate.edu/faculty/barge/articles/SmartCards.pdf discloses details of the functionality of a smart card. A hybrid smart card comprises a standard magnetic strip for credit card transactions in combination with stored rewards values within the chip of the smart card. The Smart Card Publication does not disclose a smart card adapted to communicate with a cash register machine to thereby provide the cash register machine with a merchant provided discount or loyalty card number that triggers application of discounts on merchandise acquired by a purchaser.

There remains a need in the art for a consolidated membership/reward card that is operative as a credit card, but additionally provides membership/rewards discounts at a plurality of merchant locations. Since each merchant has different loyalty programs with its own unique loyalty card identification number, there is needed a consolidated members/rewards card that emulates these unique merchant card numbers at these merchant locations.

### SUMMARY OF THE INVENTION

The present invention provides a consolidated membership/rewards card issued by a bank or card issuing authority that has a standard credit card functionality and which, additionally provides membership/rewards discounts at a plurality of merchant locations. Generally stated, the card includes an embossed or printed name of the account holder, a credit card number, an expiration date and secret card verification number, a magnetic strip coded with a credit card number and encrypted security codes. Additionally, the consolidated membership/rewards card has electronic functions operative to store a plurality of merchant names and corresponding merchant provided membership/reward card numbers. These data are enterable into the memory and are placed in communication with a check out cash register using a programmable magnetic strip or universal serial bus (USB) connection.

The consolidated membership/rewards card consolidates a plurality of vendor membership/rewards card numbers into the solid state memory of the device by the user uploading these numbers into the device and selecting a specific number to communicate with the check out cash register to receive merchant authorized discounts. The consolidated membership/rewards card is issued by a bank or credit card issuing authority that has a standard magnetic strip encoded with proper credit card numbers for swiping the card in a conventional magnetic credit card reader. This card additionally has features enabled by the credit card providing authority, which includes a combination of a unique credit card number, an expiration date, secret card code and card holder's name. With these additional features, the consolidated membership/reward card can be programmed with one or more card numbers that are provided by individual merchants. A cardholder receives discounts for purchases at pre-selected merchant locations when the merchant provided discount card number is communicated to a check out cash register during merchandise purchase at pre-selected merchant locations. The consolidated membership/rewards card may communicate with the check out machine at the merchant location by one or more methods.

In a first embodiment, the consolidated membership card may be battery powered, preferably by rechargeable batteries. A CPU, memory and software programs magnetize a second programmable magnetic strip with specific merchant's discount or loyalty card number. A display is provided, which indicates those merchants that are programmed into the memory of the consolidated membership/rewards card. The user selects a specific merchant by pressing an up or down button; then presses a ‘Go’ button to magnetize the programmable second magnetic strip. When the second magnetic strip is swiped, the cash register receives the merchant provided discount or loyalty card number and accordingly provides eligible discounts for merchandise purchased. The card may then be turned to swipe the credit card provided, permanent magnetic strip, thereby charging the purchase. The user may use other forms of payment including a cash payment, a check payment or payment by another credit card.

When the card is initially provided, the memory of the CPU in the consolidated membership/rewards card is empty. The user connects the USB port connection of the consolidated membership/rewards card to a personal computer, which appears in the computer screen as a hard drive. He creates a text file with a merchant name, a tab delimiter and the merchant provided discount or loyalty car number, followed by a carriage return. The next merchant's data is then entered. This text file is transferred to the memory of the consolidated membership/rewards card. The battery powers a display in the card, which is preferably a liquid crystal display (LCD), whereby the card shows the names of the merchant. The user can thumb through the list of merchants by pressing up or down arrow buttons to highlight a specific merchant name. When the ‘go’ button is pressed, the card number of the selected merchant is sent to a programmable second magnetic strip, which is magnetized by a plurality of inductors behind the magnetic strip. Swiping this magnetic strip with programmed merchant discount card number in a magnetic card reader communicates the merchant discount number to the check out cash register machine enabling generation of appropriate credits.

In a second embodiment, the cash register machine has a USB port to which the consolidated membership/rewards card may be directly connected using the USB connector of the card. Pressing the ‘Go’ button sends the selected merchant's card number to the cash register using USB connectivity providing eligible discounts for the purchases.

Thus the consolidated membership/rewards card has a credit card authority provided magnetic strip for conducting credit card transactions in the usual conventional manner, while the card has recoding and communicating means for storing a plurality of merchant provided discount or loyalty card numbers, and means for selecting a particular merchant and communicating the corresponding card number to a cash register to receive eligible discounts at the time of purchase. This communication method includes programming a second magnetic strip, which is on the opposite side of the credit card magnetic strip and is adapted to be swiped in a conventional magnetic card strip reader. Alternatively, this communication between the consolidated membership/rewards card and the cash register may be through the USB port of the card, which is adapted for connection to the USP terminal of the cash register.

The consolidated membership/rewards cards for consolidation of a plurality of merchant membership/reward cards broadly comprises: (i) a battery powered consolidation device having a unique credit card identification number encoded in a permanent magnetic strip; (ii) the consolidation device being issued to a user by a bank or credit card issuing authority; (iii) the user programming a plurality of merchant provided discount or loyalty card numbers into the memory of the card using a personal computer; (iii) said personal computer being connected to the consolidated membership/rewards card using a USB connection; (iv) the user uploading a text file containing merchant names and corresponding discount card numbers for storage in the card as a tab delimited text file; (v) the consolidated membership/rewards card displaying a list of merchant names; (vi) the user selecting the merchant name from a list displayed on a screen in the card by using up and down buttons; (vii) the user pressing a ‘Go’ button to communicate said merchant discount number to a cash register; (viii) the communication means being a programmable second magnetic strip that is swiped or a direct USB connection from the card to the cash register; (ix) the user being provided with eligible credits on purchases; and (x) the permanent magnetic card being swiped for charging the purchases to a credit card.

Generally the invention involves a consolidated membership /rewards card device for use when purchasing goods. Advantageously, the universal membership /reward device consolidates a plurality of vendor membership/reward cards that may be included into the memory of a single card with a credit card functionality. This card merely communicates the merchant provided discount or loyalty number to a cash register for receiving eligible discounts at the time of purchase. Advantageously, the user is relieved from (i) carrying a large number of merchant provided discount or loyalty cards; and (ii) fishing around for a correct card, as well as a credit card at the point of purchase.

In addition, there is provided a method for consolidating merchant membership/rewards cards, comprising the steps of: (i) storing a plurality of merchant provided membership numbers each being associated with a merchant in the memory of a battery powered consolidated membership/rewards card device; (ii) providing a unique permanent credit card identification number associated with the consolidation device; (iii) storing the unique identification number and associated permanent magnetic strip provided by a credit card issuing authority; (iv) communication means between the consolidated membership/ rewards card and a cash register, using either a programmable second magnetic strip or a direct USB connection; (v) transmitting to the check out cash register the merchant discount or loyalty card numbers for receiving eligible discounts for purchases; and (vi) charging the purchase using a permanent magnetic strip in the consolidated membership/rewards card in a conventional manner or using other payment means including cash, personal check or another credit card.

### BRIEF DESCRIPTION OF DRAWINGS

The invention will be more fully understood and further advantages will become apparent when reference is had to the following detailed description and the accompanying drawings, in which:

FIG. 1a illustrates a schematic view of the front face of the consolidated membership/rewards card;

FIG. 1b illustrates an end view of the consolidated membership/rewards card;

FIG. 1c illustrates a schematic view of the back face of the consolidated membership/rewards card.

### DESCRIPTION OF THE PREFERRED EMBODIMENTS

Membership or Reward cards are currently individually issued from a plethora of vendors and merchants, including supermarkets, drug stores, pharmacies, clothing stores, electronic stores, etc. Consumer's wallets are becoming cluttered and packed with all these cards taken together with their credit cards, license, bankcards, and other items. Gradually cards have to be removed from the wallet as space becomes limited. Consequently, the proper card is oftentimes not readily available at point of purchase. Failure to present a particular card to a merchant during purchase all too often results in loss of valuable membership rights or loss of associated rewards. Advantageously, the consolidated membership/rewards card provides a consolidated device in the form of a card or personal electronic device that consolidates a plurality of reward/membership cards so that a user does not have to carry each of the individual cards separately.

Credit card companies have been offering services to attract new customers, typically by offering lower initial interest rates on loans, frequent flyer miles, discount offers on novelty items or cash back bonuses. The present invention enables credit card companies to provide a credit card with functionality that is inexpensive and usable by customers, and which eliminates the need for carrying a relatively large number of merchant provided discount or loyalty cards. Advantageously, in accordance with the invention, these merchant provided discount or loyalty card numbers are seamlessly integrated into the consolidated membership/rewards card for prospective purchase of discounted merchandise.

Generally stated, the invention involves a consolidated membership/rewards card device appointed for use when purchasing goods subject to discounts or loyalties points provided by various vendors. In addition to facilitating application of discounts or loyalty points, the consolidated membership/rewards card device has functional capability to charge purchases. Preferably, the card is about 86 mm long, about 55 mm wide, about 0.8 mm thick, and meets ISO Standards associated with such cards. Magnetic strip segments of the card require a dimension of about 0.8 mm to facilitate sliding within a conventional card reader. The central portion of the card may be somewhat thicker accommodating the electronics of the device and includes a battery, CPU, LCD display, display driver electronics, and up and down and go buttons.

In one embodiment, the invention relates to a battery powered consolidated membership/rewards card issued by a bank or credit card issuing authority. The card has a front face with credit card logo, a member name, an expiration date, and a unique credit card number, together with an expiration date. The back face of the card has a secret card code and a permanent magnetically encoded strip for charging purchases by swiping the card in a conventional credit card reader. The permanent magnetic strip is typically encoded with the unique card number together with encrypted codes providing authorization of the charged purchase amount. In addition, the card has a CPU, memory and display, preferably an LCD display, up and down buttons and a ‘Go’ button, a programmable second magnetic strip on the opposite side of the credit card strip and a port enabling USB connectivity. The user programs the memory of the consolidated membership/rewards card by connecting the card to a personal computer using the USB connectivity function. A text file is created, containing a plurality of merchant names followed by a tab. The text file also indicates the merchant provided discount or loyalty card number, followed by a carriage return. This text file is transferred into the memory of the consolidated membership/rewards card and is accessed during use by software resident in the card to display the list of merchants in the LCD display of the card as a list. The user selects the desired merchant by pressing the up and down arrow, and then presses the ‘Go’ button. The programmable second magnetic strip is thereby magnetized in accordance with the merchant card number. There are a number of inductor loops behind the programmable second magnetic strip, which are first run in an AC mode to demagnetize any previously existing magnetic coding. DC current is then supplied to the induction loops to magnetize the programmable magnetic strip with the selected merchant membership/rewards card number of the selected merchant. When the programmable second magnetic strip is swiped in a magnetic card reader, the reader transmits the card number to a cash register, triggering application of eligible discounts for merchandise purchased. Alternatively, the USB connection of the card may be connected to the USB port of the cash register for communication of the merchant discount card number thereto. The permanent magnetic strip of the card may be used to charge the purchase, to which eligible discounts are applied. The user may use other means to pay for the purchase including cash payment, payment by check or payment by use of another credit card.

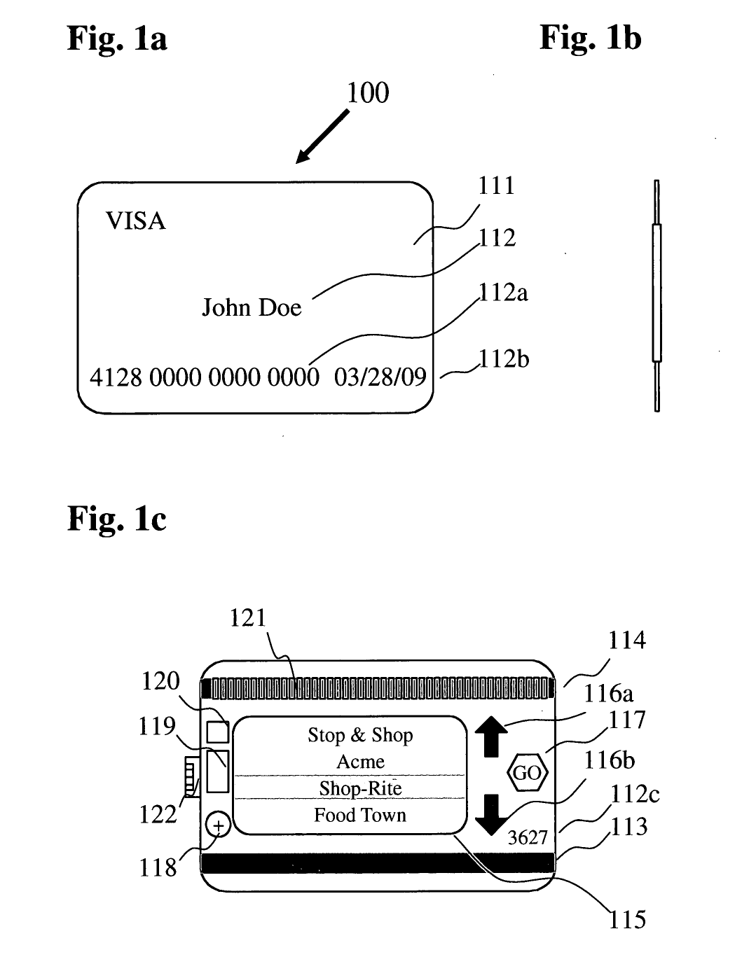

FIG. 1a illustrates a schematic view of the front face of the consolidated membership/rewards card, shown generally at 100, wherein the device is embodied in a personal device. Consolidated membership/rewards card 100 includes a personal device body 111 appointed with a unique credit card identification number 112a associated with a user name 112 shown on the front of the device body 111. The expiration date of the credit card is shown at 112b and this may be preferably a stick on indication. In this manner, the credit card company does not have to send a new card every year and the user has to upload all the merchant names and corresponding loyalty or discount numbers.

FIG. 1b shows a side view of the card. The top and bottom portions of the card are thin with a cross sectional width of 0.8 mm. This dimension is stipulated by credit card industry standards, and is a necessary prerequisite for sliding appointed for reading by a conventional magnetic card reader. On the other hand, the central portion of the card is thicker, in the range of 1 mm to 3 mm, to accommodate the electronic features of the card. These electronic features include a battery, a CPU, solid state memory, a USB connector, an inductor loop driver, inductor loops for programming the second magnetic strip, a flexible display, which is preferably an LCD display and buttons for up and down selection and a ‘GO’ button.

FIG. 3 illustrates the rear side of the consolidated membership/rewards card. A secret card code is printed at 112c and is typically used in telephone orders to indicate the physical possession of the card by the user. This secret card code is needed to process a credit card charge by a remote telephone merchant. The card has a bank or credit card issuing authority provided permanent magnetic strip 113, which is coded with the credit card number 112a of FIG. 1a and additional secret codes. A programmable second magnetic strip 114 is provided on the back surface of the device body 111 at 114 and is used to program merchant provided discount or loyalty card numbers. The consolidated membership/rewards card has a battery 118, preferably a rechargeable battery powering the device. A central processing unit or CPU is shown at 119. An inductor loop driver is shown at 120. The flexible display, preferably an LCD display is shown at 115. Up and down selection buttons are shown at 116a and 116b. A ‘GO’ button is shown at 117.

When the card is initially shipped to the user by the bank or credit card issuing authority, the memory contains no data. The user connects the consolidated membership/rewards card to a personal computer using the USB connector shown at 122. The user creates a text file with merchant name or identity, a tab character followed by the merchant provided loyalty or discount card number followed by a carriage return. The user then proceeds to fill in the data for the next merchant. This text file is uploaded to the memory of the consolidated membership/rewards card. The USB link with the personal computer is now disconnected.

The software resident in the consolidated membership/rewards card displays the list of merchant names on the flexible LCD screed 115 of the consolidated membership/rewards card. The user may use the up and down buttons 116a or 116b to highlight or select a particular merchant and then press the ‘GO’ button 117. Pressing this ‘GO’ button causes the CPU to drive the inductor loops 121 placed below the programmable second magnetic strip 114 using an AC power to erase any previously stored loyalty or discount number. Next, the CPU magnetizes the programmable magnetic strip with the number corresponding to the loyalty or discount number of the user-selected merchant. This magnetization is achieved by the inductor loops 121. The consolidated membership/rewards card is now ready for swiping in a magnetic card reader to communicate the merchant loyalty or discount number to a check out cash register machine. At the same time when the ‘GO’ button 117 is pressed, the CPU sends out the merchant provided loyalty or discount number through the USB link to a check out cash register machine that is enabled with a USB connector.

To program the consolidated membership/rewards card for a particular merchant a user selects a particular merchant from a list of merchants displayed on a display 115, pressing up and down arrows 116a and 116b and pressing the ‘GO’ button 117. The device is powered by a battery 118 that is connected to a CPU 119 with memory that drives a magnetic inductor driver 120, which changes the magnetic polarity of induction loop elements 121 embedded below the programmable second magnetic strip 114. The card has USB connections 122 which are used to connect the card to a personal computer to upload a list of merchants and their corresponding discount or loyalty numbers into the memory of the card. The USB connection may also be used to directly connect the card to a cash register USB terminal to communicate the card number to the cash register to provide discounts for eligible merchandise purchased. The end view of the consolidated membership/rewards card is shown in FIG. 1b wherein the card has a thickness of 0.8 mm where the magnetic strips are present, and the central portion of the card is thicker, typically in the range of 1 mm to 3 mm, to accommodate the electronics, buttons, display and battery.

The consolidated membership/rewards card comprises, in combination, the following salient features:
1. a bank or credit card issuing authority provided battery powered consolidated membership/rewards card;
2. said card having a front face imprinted or embossed card holder name, unique credit card identification number and credit card expiration date;
3. said card having a rear face indicating a secret card authorization printed code and a permanent magnetic strip encoded with said unique credit card identification number, together with secret codes authorizing purchases when said permanent magnetically encoded strip is swiped through a conventional interface of a credit card magnetic reader for charging purchases;
4. said consolidated membership/rewards card having a CPU, memory, software resident in said memory, a USB connector, a flexible display, such as an LCD display, and a programmable second magnetic strip on the rear face of the card in a local opposite to that of the credit card permanent magnetic strip;
5. said card being connected to a personal computer using a USB connection to upload a text file that lists sequentially, the merchant, name and corresponding merchant discount or loyalty card numbers in a tab delimited format;
6. said card displaying a list of merchant names on said display and the user, during purchase of merchandise, selecting a merchant by pressing up and down buttons, and then pressing a ‘GO’ button, to magnetize the programmable second magnetic strip, and transmitting said merchant discount or loyalty card number through a USB terminal;
whereby the merchant provided discount or loyalty card number is communicated to said cash register by swiping the programmable second magnetic strip in said magnetic card reader, or by direct USB connection of the card with the cash register, triggering application of eligible discounts to user effected purchases, and such user effected purchases are paid for by swiping the permanent magnetic strip of said consolidated membership/rewards card or by cash, check or another credit card.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A consolidated membership/rewards card, comprising:
a. a card issued by a bank or credit card issuing authority, and having functionality of a conventional credit card;
b. said consolidated membership/rewards card having a battery powering a CPU, a memory, software resident in said memory, a USB connector, a flexible display, and a programmable second magnetic strip on the rear face of the card in a local opposite to that of said credit card permanent magnetic strip;
c. said consolidated membership card displaying from said memory a list of merchant names on said flexible display and a user selecting a merchant name by pressing up and down buttons and pressing go to magnetize said programmable second magnetic strip with a merchant provided loyalty or discount number and at the same time transmitting said number through said USB connection;
d. said consolidated membership card communicating said merchant provided loyalty or discount number to a check out cash register of the merchant upon swiping of said programmable magnetic strip or by establishing a direct USB link between said card and a USB enabled cash register;
whereby the user is provided with appropriate discounts on purchases made and payment for such purchases is effected by swiping said consolidated membership/rewards card permanent magnetic strip or other payment means.

2. A consolidated membership/rewards card as recited by claim 1, wherein said front face has imprinted or embossed thereon a card holder's name, a unique credit card identification number, and a credit card expiration date.

3. A consolidated membership/rewards card as recited by claim 1, wherein said rear face indicates a secret card authorization printed code.

4. A consolidated membership/rewards card as recited by claim 1, wherein said permanent magnetic strip encodes said unique credit card identification number, together with secret codes provided by said bank or credit card issuing authority.

5. A consolidated membership/rewards card as recited by claim 1, wherein said flexible display is a liquid crystal, LCD, display.

6. A consolidated membership/rewards card as recited by claim 1, wherein said programmable magnetic second strip is magnetized by a plurality of induction loops directly below the programmable magnetic strip.

7. A consolidated membership/rewards card as recited by claim 6, wherein said programmable magnetic second strip is first demagnetized by passage of AC current through said plurality of induction loops directly below the programmable magnetic strip to erase a previously recorded merchant provided loyalty or discount number.

8. A consolidated membership/rewards card as recited by claim 1, wherein said card is connected to a personal computer using a USB connection to upload a text file that lists sequentially, merchant names and corresponding merchant discount or loyalty card numbers in a tab delimited format.

9. A consolidated membership/rewards card as recited by claim 1, wherein said card has a thickness of 0.8 mm at the permanent magnet strip and programmable magnetic strip location for insertion into a magnetic card reader.

10. A consolidated membership/rewards card as recited by claim 1, wherein said card has a thickness of in the range of 1 to 3 mm in the central portion of said card.

11. A consolidated membership/rewards card as recited by claim 1, wherein said other payment means includes cash payment, payment by check or payment by another credit card.
